(19) United States
(12) Patent Application Publication
(10) Pub. No.: US 2010/0190087 A1
(43) Pub. Date: Jul. 29, 2010

(54) FUEL CELL

(76) Inventors: Yuichi YOSHIDA, Tsukuba-shi (JP); Hiroyuki Hasebe, Chigasaki-shi (JP); Nobuyasu Negishi, Yokohama-shi (JP); Koichi Kawamura, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/726,236

(22) Filed: Mar. 17, 2010

Related U.S. Application Data
(63) Continuation of application No. PCT/JP2008/067033, filed on Sep. 19, 2008.

(30) Foreign Application Priority Data
Sep. 19, 2007 (JP) 2007-242948
Jan. 8, 2008 (JP) 2008-001426

(51) Int. Cl. H01M 8/10

(52) U.S. Cl. 429/483

(57) ABSTRACT

A fuel distribution mechanism of a fuel cell, including a fuel inlet communicating with the supply channel, a plurality of fuel outlets which are open so as to be opposite the fuel electrode, and a fuel passage communicating with the fuel inlet and the fuel outlets in order to circulate the fuel from the fuel inlet to the fuel outlets, and the fuel passage is formed between the fuel inlet and the fuel outlets and comprises a plurality of branch passages that are adjusted in passage cross-sectional shape and branch structure as the branch passages extend from upstream to downstream between the fuel passage situated upstream and the fuel outlets and that have a desired channel resistance.

### CROSS REFERENCE TO RELATED APPLICATIONS

This is a Continuation Application of PCT Application No. PCT/JP2008/067033, filed Sep. 19, 2008, which was published under PCT Article 21(2) in Japanese.

This application is based upon and claims the benefit of priority from prior Japanese Patent Applications No. 2007-242948, filed Sep. 19, 2007; and No. 2008-001426, filed Jan. 8, 2008, the entire contents of both of which are incorporated herein by reference.

### BACKGROUND OF THE INVENTION

1. Field of the Invention

The present invention relates to a fuel cell disposed in a surface, which is effective to operate a mobile apparatus, and more particularly to an internal-vaporization type direct methanol fuel cell (DMFC).

2. Description of the Related Art

In recent years, various types of electronic device such as personal computers and mobile telephones have been reduced in size as semiconductor technology advances, and there have been attempts to use a fuel cell as the power source in such small devices. A fuel cell has such advantages as being able to generate power merely by supplying fuel and oxidizer thereto, and continuously generate power merely by adding or replacing the fuel. Therefore, if miniaturization could be achieved, it would create an extremely advantageous system for the operation of mobile electronic apparatuses. In particular, the direct methanol fuel cell (DMFC) uses methanol with a high energy density as its fuel and can generate an electric current on the electrode catalyst from methanol, making it easily reducible in size. Since the handling of the fuel is easy compared to handling hydrogen gas fuel, it is a power source with much potential for small devices. Accordingly, the practical use of direct methanol fuel cells as power sources optimal for cordless mobile devices such as mobile phones, mobile audios, mobile game machines, and notebook type personal computers is anticipated.

Known methods for supplying the fuel via DMFC include a gas supply type DMFC for sending a liquid fuel into the fuel cell with a blower or the like after vaporizing the liquid fuel, a liquid supply type DMFC for sending a liquid fuel into the fuel cell directly with a pump or the like, and an internal-vaporization type DMFC for vaporizing a liquid fuel within a cell.

For example, Patent Document 1 proposes a structure for an internal-vaporization type DMFC, which is one of the known methods, the structure being configured such that a membrane electrode assembly (MEA) comprising a fuel electrode, electrolyte membrane, and air electrode is disposed on a fuel storage part formed from a box-shaped container made of resin. When vaporized fuel is directly supplied to the MEA from the fuel storage part, it is important to enhance the ability to control fuel cell output. However, conventional internal-evaporation type DMFCs have not yet acquired a satisfactory ability to control output.

On the other hand, Patent Documents 2 to 4 propose that an MEA for a DMFC and a fuel storage part be connected via a channel. Liquid fuel supplied from the fuel storage part is further supplied to the MEA via the channel, thereby enabling adjustment of the quantity of liquid fuel supplied depending on the shape, diameter, etc., of the channel. However, depending on a structure for supplying liquid fuel via a channel, uniform supply of fuel to the MEA may not be ensured, leading to a decrease in fuel cell output. For example, when a liquid fuel is circulated along a groove-like channel, the liquid fuel is gradually consumed as it flows within the channel. Consequently, the fuel concentration is decreased on the exit side of the channel. Accordingly, power generating reaction diminishes near the exit of the MEA channel, and hence output decreases.

Patent Document 3 proposes a fuel cell system that uses a pump for supplying liquid fuel to an MEA from a fuel storage part via a channel. This Patent Document 3 also describes the use of an electric field generating means (an electro-osmotic flow pump) instead of a general-purpose pump, the electric field generating means being used to cause an electro-osmotic flow in the channel.

Patent Document 4 proposes a fuel cell system that supplies liquid fuel by means of an electro-osmotic flow pump. In a fuel cell using a fuel circulation structure, a pump is effective. However, when fuel is not circulated as in the internal-evaporation type DMFC, using a pump simply results in an increase in fuel consumption and makes it difficult to initialize a uniform reaction of electricity generation throughout an MEA.

Patent Document 1: International Publication No. 2005/112172 Pamphlet

Patent Document 2: Jpn. PCT National Publication No. 2005-518646

Patent Document 3: Jpn. Pat. Appln. KOKAI Publication No. 2006-085952

Patent Document 4: U.S. Patent Application Publication No. 2006/0029851

### BRIEF SUMMARY OF THE INVENTION

However, in a conventional internal-vaporization type DMFC, in order to evenly supply liquid fuel to the entire surface of the MEA fuel electrode, a distribution plate is disposed immediately in front of a gas-liquid separation film in a vaporizing chamber, and liquid fuel is circulated in a plurality of branch channels formed in the distribution plate. However, because pressure losses in branch channels are great, high pump backpressure is required, resulting in considerable load on the pump. If pump backpressure is excessive, air bubbles may easily be produced in the channels and lead to so-called air bubble blockage, which prevents the smooth flow of liquid fuel. If air bubble blockages arise, electricity generation output decreases or varies.

The present invention has been made to solve the foregoing problems. It is accordingly an object of the present invention to provide a fuel cell able to supply a liquid fuel at a desired flow rate to the trailing ends of branch passages in a fuel distribution mechanism without causing any air bubble blockage and able to mitigate load on a liquid feed pump.

The inventors proposed a basic structure for a fuel distribution mechanism disclosed in the specification, etc., of Japanese Patent Application No. 2006-353947, and have conducted earnest study and development thereafter. As a result, the inventors have modified this invention and established technology for uniformly and efficiently supplying liquid fuel to a fuel electrode without causing any air bubble blockage.

A fuel cell comprising: an membrane electrode assembly including a fuel electrode, an air electrode, and an electrolyte membrane sandwiched between the fuel electrode and the air electrode; a fuel distribution mechanism disposed on a side of the fuel electrode of the membrane electrode assembly and configured to distribute and supply fuel to a plurality of areas of the fuel electrode; a fuel storage part configured to store liquid fuel; and a supply channel configured to communicate with the fuel storage part to the fuel distribution mechanism,

wherein the fuel distribution mechanism comprises:

a fuel inlet communicating with the supply channel; a plurality of fuel outlets which are open so as to be opposite the fuel electrode; and a fuel passage communicating with the fuel inlet and the fuel outlets in order to circulate the fuel from the fuel inlet to the fuel outlets, and

wherein the fuel passage is formed between the fuel inlet and the fuel outlets, and the fuel passage includes a plurality of branch passages that are adjusted in passage cross-sectional shape and branch structure as the branch passages extend from upstream to downstream between the fuel passage situated upstream and the fuel outlets, so as to have a desired channel resistance.

In the foregoing, it is preferable that the branch passages diverge from the upstream fuel passages or upstream branch passages such that the cross section of each channel gradually decreases as the branch passages extend from upstream to downstream, and that the trailing ends of the branch passages communicate with the fuel outlets. This enables distribution of an appropriate quantity of liquid fuel to the plurality of branch passages by means of appropriate but not excessive pump backpressure. This also prevents formation of air bubbles in the liquid fuel within the passages and hence air bubble blockages.

It is preferable that each of the upstream fuel passages and branch passages be formed from one or more thin tubes. In particular, it is preferable that each upstream fuel passage be formed from a single thin tube of uniform diameter. Since the upstream fuel passages function as headers for distributing liquid fuel to the plurality of branch passages, they have to evenly distribute and supply the liquid fuel to the branch passages.

It is preferable that the downstream branch passages be smaller in equivalent diameter than the upstream branch passages. The equivalent diameter is defined in the manner described below.

“Equivalent diameter” is an index obtained by converting a shape other than a circle (e.g., a rectangle) into the diameter of a circle (true circle), and is obtained by dividing the sectional area (a×b) by the circumferential length (2a+2b) of the cross section of the channel and then multiplying this result by four. That is, an equivalent diameter de can be calculated by substituting the cross-sectional dimensions a and b of the channel into equation (1) given below. For example, the equivalent diameter de of a channel whose height a is 50 μm and width b is 25 μm is 33.3 μm.

de=4ab/(2a+2b) (1)

It is preferable that the upstream fuel passages and branch passages be formed so that a channel cross-section has a vertical-to-horizontal ratio of approximately 1. In particular, when the upstream fuel passages have a vertical-to-horizontal ratio of approximately 1, pressure losses in the upstream fuel passages can be suppressed and the header functions of these fuel passages are outstandingly clear.

It is preferable that each branch passage have a channel cross-section area that is small near the corresponding fuel outlet so that the quantity of liquid fuel transported is controlled by a drive force mainly of capillary force. In the fuel distribution mechanism of a so-called semi-passive system, which supplies and distributes liquid fuel to the membrane electrode assembly in combination with capillary force and pump drive force, load on the pump increases exponentially as the number of fuel outlets increases, and the role of capillary force comparatively increases. When the trailing end of each branch passage is, for example, 50 μm and 25 μm in height a and width b, respectively (i.e., 33.3 μm in equivalent diameter) as described above, sufficient capillary force is generated and load on the pump is greatly mitigated.

It is preferable that the upstream fuel passages and branch passages be formed so as to cause a liquid fuel to flow in the branch passages so that laminar flow occurs at a Reynolds number of 2000 or below. This is because the critical Reynolds number at which fluid is changed from a laminar flow to a turbulent flow is in the range of approximately 2000 to 3000.

The Reynolds number (dimensionless) is the state of flow in a channel, that is, an index that indicates the magnitude of inertia relative to the viscosity of a fluid, and is given by formula (2) below.

Re=(u×de×ρ)/μ (2)

In the formula, u is flow velocity, de is equivalent diameter, ρ is fluid density, and μ is fluid viscosity.

It is preferable that each branch passage be formed so that the total of the channel cross-sectional areas before the divergence is equal to that after the divergence, and the channel cross-sectional areas after the divergence are substantially equal to one another. A fuel distribution mechanism with such a branch structure minimizes channel resistance and effectively prevents any air bubble blockages.

In the present invention, it is preferable that at least part of each fuel passage have branch passages, which diverge from the fuel passage in two or more directions and then converge.

In this configuration, each fuel passage has passages which diverge in at least two directions and then converge. Therefore, even if air bubbles enter the fuel passage and block, for example, one of the branch passages, the fuel can be circulated via the other branch passages. This mitigates the air bubble blockage, enabling a stable supply of fuel to the fuel outlets.

In particular, when each fuel passage diverges a plurality of number of times and fuel is supplied to a plurality of fuel outlets, it is preferable to dispose branch passages between the points of divergence.

In the present invention, it is preferable that each of the plurality of fuel passages diverge at least once between the fuel inlet and the corresponding fuel outlet such that the equivalent diameter before and after divergence gradually decreases and the trailing end of the fuel passage communicates with the fuel outlet.

In the present invention, the branch passages are preferably formed such that the intervals between the branch passages increase toward the fuel outlets from the fuel inlet. Thus, pressure loss can be minimized on the upstream side (fuel inlet side) of each fuel passage and fuel can be supplied to the trailing ends of the many passages on the downstream side (fuel outlet side) as evenly as possible. Accordingly, fuel can be evenly dispersed and supplied via the many fuel outlets.

In the present invention, it is preferable that each branch passage have a rectangular channel cross-section with an aspect ratio of approximately 1. The rectangular channel cross-section with an aspect ratio of approximately 1 decreases channel resistance and makes it possible to disperse and feed fuel to the trailing ends of the passages with less liquid feed force.

In the present invention, it is preferable that each branch passage have an equivalent diameter by which, near the fuel outlet, the fuel is fed mainly with capillary force and a quantity of liquid fed is controlled by capillary resistance. In this case, “capillary force” is the driving force of the liquid, which mainly includes interfacial energy produced by the surface tension in capillarity. Additionally, “capillary resistance” means capillary force decrease (energy loss) caused by fluid friction between the fluid and the internal wall. In the fuel distribution mechanism of a so-called semi-passive system, which supplies and distributes liquid fuel to a membrane electrode assembly in combination with capillary force and pump drive force, load on the pump increases exponentially as the number of fuel outlets increases, and the role of capillary force comparatively increases.

It is preferable that there be only one fuel inlet. Introducing liquid fuel from the single fuel inlet to the fuel distribution mechanism minimizes variations in fuel supply pressure and fuel density, thus making it possible to evenly distribute the liquid fuel throughout the fuel electrode. As a matter of course, fuel inlets may be disposed in a plurality of areas and a liquid fuel may be introduced to the liquid distribution mechanism from these fuel inlets.

It is preferable that the liquid fuel be a methanol solution or pure methanol liquid, which has a methanol concentration of 80 mol % or more. If the fuel concentration is 80 mol % or less, output decreases easily and hence frequency of liquid fuel supply increases.

### BRIEF DESCRIPTION OF THE SEVERAL VIEWS OF THE DRAWING

FIG. 1 is an internal perspective view of a fuel cell according to a first embodiment of the present invention.

FIG. 2 is a schematic plan view illustrating the outline of a fuel channel in a fuel distribution mechanism.

FIG. 3 is a schematic cross-sectional view illustrating the fuel channel in Example, whose cross-section gradually decreases each time the fuel channel diverges.

FIG. 4 is a characteristic diagram illustrating the relation between a channel length L and a pressure P in the embodiment and Comparative Example.

FIG. 5A illustrates a channel concept for a straight tube channel.

FIG. 5B illustrates a channel concept for a branch tube channel.

FIG. 6 is an internal perspective view schematically illustrating a fuel cell according to a second embodiment.

FIG. 7 is a schematic plan view of a fuel distribution mechanism according to the embodiment.

FIG. 8A is a schematic plan view of a fuel passage and a sectional view of a branch passage in the embodiment.

FIG. 8B is a perspective view of port (region of bypass hole) at a branch point of the fuel passage.

FIG. 9A is an exploded perspective view of the branch passage according to the embodiment.

FIG. 9B is an exploded perspective view of a conventional fuel passage.

FIG. 10 is a characteristic diagram illustrating a change in fuel flow rate with time in Example and Comparative Example.

FIG. 11 is a schematic model diagram of branch passages (fuel channels) in Example and Comparative Example.

FIG. 12 is a characteristic diagram illustrating flow rates in the branch channels (fuel passages) in Example and Comparative Example.

FIG. 13 is a schematic sectional view of a fuel cell according to another embodiment.

### DETAILED DESCRIPTION OF THE INVENTION

Referring to the accompanying drawings, the best modes for carrying out the present invention will hereinafter be described.

### First Embodiment

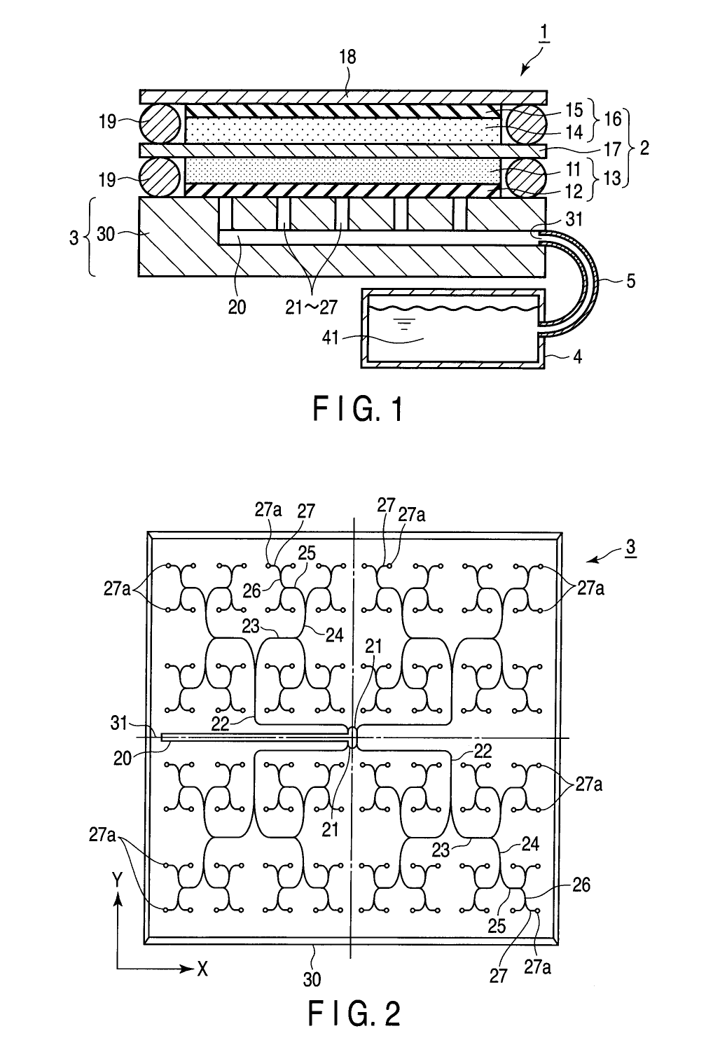

First, the schematic outline of the overall fuel cell will be described with reference to FIG. 1.

A fuel cell 1 according to a first embodiment is covered with an outer case 18 and a distribution plate 30 of a fuel distribution mechanism 3, and a membrane electrode assembly (MEA) 2 is accommodated in the fuel cell 1. The outer case 18 and the distribution plate 30 are screwed together, with the MEA 2 sandwiched therebetween, and the ends of the outer case 18 are caulked to the distribution plate 30, thereby integrating them. A pair of O-rings 19 is disposed on the periphery of the MEA 2, thereby sealing the space between the outer case 18 and MEA 2 and also the space between the distribution plate 30 and MEA 2, thus preventing fuel inside from leaking.

The MEA 2 is a power generating element that has a multi-polar structure including a plurality of strips of single electrodes (unit cells) arranged on substantially the same flat surface and electrically connected in series. In the present embodiment, a description is given using as an example a four-series fuel cell, in which four single electrodes are connected in series. Each of the unit electrodes has the MEA 2, a positive electrode current collector (cathode conductive layer) and a negative electrode current collector (anode conductive layer), both of which are not shown.

The positive electrode current collector is provided with a moisturizing plate (not shown), which prevents, for example, ingress or contact of fine dust and foreign matter from outside without blocking the free passage of outside air. As such a moisturizing plate, a film with a porosity of, for example, 20 to 60%, is to be preferred. In order to introduce air, a plurality of air holes (not shown) are formed in the main surface of the outer case 18. Air enters through these air holes and is supplied to an air electrode (cathode) 16 of the MEA 2 through the moisturizing plate.

Examples of a catalyst contained in a fuel electrode 13 and the air electrode 16 include a simple substance from the platinum group of metals (such as Pt, Ru, Rh, Ir, Os or Pd) or an alloy containing a member of this group. As an anode catalyst, methanol or Pt—Ru with a high CO tolerance performance, and as a cathode catalyst, platinum, are to be preferred. However, the present invention is not limited thereto. In addition, a supported catalyst using a conductive support such as a carbon material may be used. Alternatively, a non-supported catalyst may be used.

An electrolyte membrane 17 is provided to transport a proton, produced in the fuel electrode 13, to the air electrode 16, and this membrane is formed from a material that is not electron-conductive but able to transport protons. Examples of such a material include a fluororesin containing a sulfonic group (e.g., perfluorosulfonic acid polymer), a hydrocarbon resin containing a sulfonic group, a tungstic acid, and a phosphotungstic acid. Specifically, the electrolyte membrane 17 is formed from “Nafion” (registered trademark) membrane manufactured by DuPont, “Flemion” (registered trademark) membrane manufactured by Asahi Glass Co., Ltd., or “Aciplex” (registered trademark) manufactured by Asahi Kasei Corporation. The electrolyte membrane 17 may be formed from, in lieu of a polyperfluorosulfonic acid resin membrane, any other material which can transport protons, such as a copolymer membrane of a trifluorostyrene derivative, a phosphoric-acid-containing-polybenzimidazole membrane, an aromatic polyether ketone sulfonic acid membrane, or an aliphatic hydrocarbon resin membrane.

As shown in FIG. 1, disposed on the fuel electrode (anode) 13 side of the MEA 2 is the fuel distribution mechanism 3. This fuel distribution mechanism 3 is connected to a fuel storage part 4 via a supply channel 5. A liquid fuel 41 is introduced into the fuel distribution mechanism 3 from the fuel storage part 4 via the supply channel 5 by a predetermined fuel supply system. The fuel supply system may be a purely passive system or a semi-passive system. The fuel cell 1 according to the present embodiment, shown in FIG. 1, adopts a purely passive system that utilizes only capillary force, but may adopt a semi-passive system, which utilizes a combination of capillary and pump drive force. The semi-passive system is described in detail in the specification of JP-A No. 2006-353947 (JP-A KOKAI No. 2008-235243) applied by the inventors of the present invention. The supply channel 5 is not limited to a tube independent of the fuel distribution mechanism 3 and fuel storage part 4. For example, when the fuel distribution mechanism 3 and fuel storage part 4 are integrated by being stacked in layers, the supply channel 5 may serve as a liquid fuel passage connecting them.

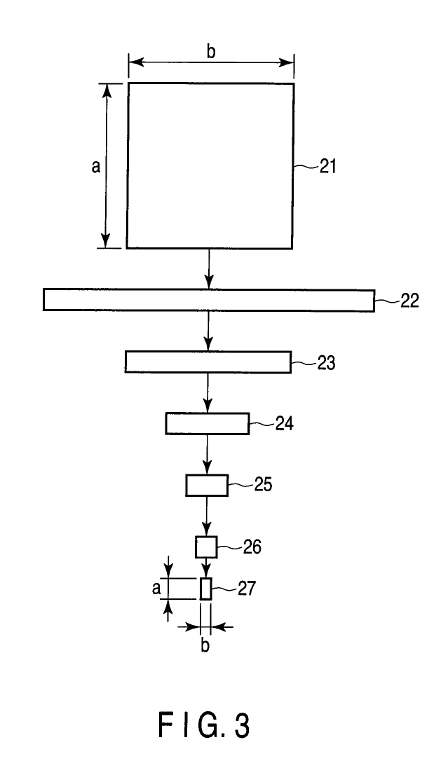

As shown in FIG. 2, the fuel distribution mechanism 3 comprises the distribution plate 30. The distribution plate 30 comprises: one fuel inlet 31; an introduction tube 20 communicating with the fuel inlet 31; upstream fuel passages 21 communicating with the introduction tube 20; first to sixth branch passages 22 to 27, which diverge one after another in sequence from the upstream fuel passages 21; and fuel outlets 27a, which are open at the trailing ends of the corresponding sixth branch passages 27 located in the rearmost positions. The fuel inlet 31 is continuous with one end (the leading end) of the introduction tube 20. The introduction tube 20 is formed from a thin tube of rectangular cross-section with uniform diameter (e.g., an equivalent inside diameter of 0.05 to 5 mm). The introduction tube 20 functions as a header, which delivers liquid fuel to the passages 21 to 27 via this tube 20.

From the inlet tube 20, the four upstream fuel passages 21 diverge. From each upstream fuel passage 21, the two first branch passages diverge. From each first branch passage 22, the two second branch passages 23 diverge. From each second branch passage 23, the two third branch passages 24 diverge. From each third branch passage 24, the two fourth branch passages 25 diverge. From each fourth branch passage 25, the two fifth branch passages 26 diverge. From each fifth branch passage 26, the two sixth branch passages 27 diverge. The total number of sixth branch passages 27 located in the rearmost positions is 128, and a fuel outlet 27a is open at the trailing end of each sixth branch passage 27. All these fuel outlets 27a are oriented in the direction of the fuel electrode 13 of the MEA 2.

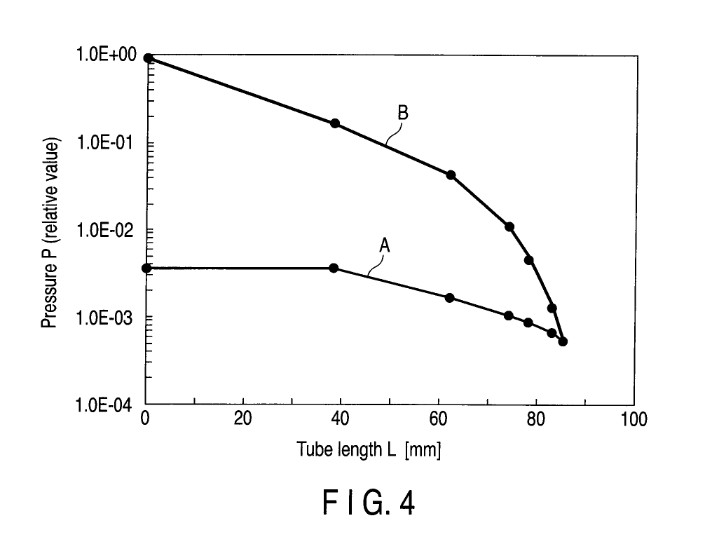

Next, the branch passages of the fuel distribution mechanism will be described in detail with reference to FIG. 3 and Table 1.

The present embodiment uses, as the introduction tube 20, an angular nonmetal, such as resin or ceramic, tube of rectangular cross-section with an equivalent inside diameter of 1.2 mm. As the upstream fuel passage 21, an angular nonmetal, such as resin or ceramic, tube of square cross-section with inside measurements of 400 μm height×400 μm width×3 mm length is used. The first branch passage 22 is 2 mm long and has a rectangular cross-section whose height “a” is 50 μm and width “b” is 800 μm. The second branch passage 23 is 6 mm long and has a rectangular cross-section whose height “a” is 50 μm and width “b” is 400 μm. The third branch passage 24 is 5 mm long and has a rectangular cross-section whose height “a” is 50 μm and width “b” is 200 μm. The fourth branch passage 25 is 14 mm long and has a rectangular cross-section whose height “a” is 50 μm and width “b” is 100 μm. The fifth branch passage 26 is 25 mm long and has a square cross-section whose height “a” is 50 μm and width “b” is 50 μm. The sixth branch passage 27 is 45 mm long and has a rectangular cross-section whose height “a” is 50 μm and width “b” is 25 μm. As described above, the first to sixth branch passages 22 to 27 other than the upstream fuel passage 21 have the same height “a” (=50 μm) due to the manufacturing process (described below). The total length from the fuel inlet 31 to the fuel outlet 27a is about 100 mm.

TABLE 1

| | |
|---|---|
| Example 1 | Comparative Example |

| | a (μm) | b (μm) | a (μm) | b (μm) |
|---|---|---|---|---|
| Upstream fuel | 400 | 400 | 25 | 50 |
| passage | | | | |
| First branch | 50 | 800 | 25 | 50 |
| passage | | | | |
| Second branch | 50 | 400 | 25 | 50 |
| passage | | | | |
| Third branch | 50 | 200 | 25 | 50 |
| passage | | | | |
| Fourth branch | 50 | 100 | 25 | 50 |
| passage | | | | |
| Fifth branch | 50 | 50 | 25 | 50 |
| passage | | | | |
| Sixth branch | 50 | 25 | 25 | 50 |
| passage | | | | |

A method for manufacturing the distribution plate 30 for the fuel distribution mechanism 3 will be briefly described next.

The distribution plate 30 is formed from a resin, such as polyethylene (PE), which is a material able to bear an etched pattern. Two resin plates are prepared. Spaces for the first to sixth branch passages 22 to 27 and upstream fuel passage 21, fuel outlets 27a, etc., are defined on one side of one of the resin plates by pattern etching using photolithography. Ceramic angular tubes are sandwiched between the pattern-etched resin plate and the other resin plate (flat plate), and the plates are bonded with an adhesive. The ceramic angular tubes serve as the introduction tube 20 and the upstream fuel passages 21. The two resin plates and the ceramic angular tubes are integrated by the adhesion. The periphery of this pre-molding is trimmed and any burrs are removed from the fuel outlet 27a. In this manner, a required distribution plate 30 is obtained. The supply channel 5 extending from the fuel storage part 4 is connected to the fuel inlet 31 of the thus manufactured distribution plate 30. Then, this distribution plate 30 is combined with the outer case 18 and the MEA 2, thereby providing a required fuel cell 1. A method for manufacturing such a micro-channel passage is described in detail in JP-A KOKAI No. 2006-18740.

A liquid fuel flows in the fuel cell 1 in a manner described below.

The liquid fuel introduced to the distribution plate 30 from the fuel inlet 31 flows through upstream fuel passages 21 from the introduction tube 20, and is led to the plurality of fuel outlets 27a via the first to sixth branch passages 22 to 27 extending in a corresponding plurality of directions. Each of the fuel outlets 27a has a gas-liquid separation film (not shown) through which, for example, vaporized components of the liquid fuel are passed but its liquid components are not passed. Consequently only the vaporized components of the liquid fuel are passed through the film and supplied to the fuel electrode (anode) 13 of the MEA 2. Accordingly, the vaporized components of the liquid fuel are emitted toward the plurality of fuel electrodes 13 from the plurality of fuel outlets 27a. As a separator, a gas-liquid separation film or the like may be installed between the fuel distribution mechanism 3 and the fuel electrode 13.

Another gas-liquid separation film (not shown) is provided between the fuel distribution mechanism 3 and the MEA 2 in order to pass the liquid fuel emitted from the plurality of fuel outlets 27a or the vaporized components of the liquid fuel, through a gas diffusion layer 12 formed in the fuel electrode 13. This gas-liquid separation film has the property of allowing the passage of only the vaporized components of a liquid fuel (e.g., methanol solution) but blocking the passage of the liquid fuel itself. As a gas-liquid separation film, a porous film such as a silicon sheet or PTFE film is used. In this case, when liquid methanol is used as a liquid fuel, the vaporized component of the liquid fuel is vaporized methanol. When a methanol solution is used as a liquid fuel, the vaporized component thereof is a gas mixture, which contains the vaporized component of the methanol and a vaporized component of water.

The plurality of fuel outlets 27a are formed in a surface of the distribution plate 30 that is in contact with the fuel electrode 13 so that the fuel can be supplied throughout the MEA 2. In four-series connection, four or more fuel outlets 27a are required. However, in order to ensure an adequate and uniform supply of fuel into the surface of the MEA 2, it is preferable that one to sixteen fuel outlets 27a per cm² be provided. Less than one fuel outlet 27a per cm² cannot supply fuel to the MEA 2 sufficiently uniformly. More than sixteen fuel outlets 27a per cm² do not yield a significantly improved effect.

The fuel emitted from the fuel distribution mechanism 3 is supplied to the fuel electrode 13 of the MEA 2 as described above. Within the MEA 2, the fuel is diffused by the anode gas diffusion layer 12 and supplied to an anode catalyst layer 11. When methanol fuel is used as the liquid fuel, an internal reforming reaction of methanol, described by the formula (1) below, occurs in the anode catalyst layer 11. When pure methanol is used as the liquid fuel, water produced in a cathode catalyst layer 14 or water in the electrolyte membrane 17 reacts with methanol to cause the internal reforming reaction described in the formula (1). Alternatively, the internal reforming reaction is initiated using another reaction mechanism that does not require water.

CH₃OH+H₂O→CO₂+6H⁺+6e⁻ (1)

An electron (e⁻) produced by the reaction is led to the outside via the current collector, and further led to the cathode (air electrode) 16 after being used as electricity to operate a mobile electronic apparatus or the like. A proton (H⁺) produced in the internal reforming reaction described in the formula (1) is led to the cathode 16 via the electrolyte membrane 17. Air is supplied to the cathode 16 as an oxidizing agent. An electron (e⁻) and a proton (H⁺) that have reached the cathode 16 react with oxygen in air in the cathode catalyst layer 14 according to formula (2) described below, yielding water as a result of the reaction.

6e⁻+6H⁺+( 3/2)O₂→3H₂O (2)

Since the plurality of fuel outlets 27a are arranged so that fuel can be supplied along the entire surface of the MEA 2, the fuel can be uniformly supplied to the MEA 2. That is, the fuel is equally distributed within the surface of the anode (fuel electrode) 13. Accordingly, the fuel required for a power generating reaction in the MEA 2 can be sufficiently supplied throughout the MEA 2. This enables the efficient initiation of a power generating reaction in the MEA 2 without complicating or increasing the size of the fuel cell 1. This improves the output of the fuel cell 1. In other words, the output and stability of the fuel cell 1 can be improved without degrading the advantages of a passive system fuel cell 1 that does not circulate fuel.

Using the fuel distribution mechanism 3 with such a structure enables liquid fuel injected into the fuel distribution mechanism 3 from the fuel inlet 31 to be distributed to the fuel outlets 27a evenly regardless of the outlet directions or positions. This further enhances the uniformity of power generating reaction within the surface of the MEA 2.

The fuel cell 1 according to the present invention uses a fuel distribution mechanism 3 comprising a plurality of fuel outlets 27a as described above. The liquid fuel 41 is introduced from the fuel inlet 31 into the fuel distribution mechanism 3 through the supply channel 5. In the fuel distribution mechanism 3, the liquid fuel 41 flows into the introduction tube 20, which is a straight narrow tube. This liquid fuel is then distributed to the four upstream fuel passages 21 sequentially diverging from the introduction tube 20, and is further distributed to the first to sixth branch passages 22 to 27. Finally these streams of liquid fuel are simultaneously discharged toward the fuel electrode 13 of the MEA 2 from the fuel outlets 27a located in 128 areas communicating with the trailing ends of the sixth branch passages 27.

The introduction tube 20 and upstream fuel passages 21 function as headers. Therefore, liquid fuel 41 of predetermined concentration is discharged from each of the fuel outlets 27a. In addition, since the plurality of fuel outlets 27a are arranged so that fuel is supplied to the entire surface of the MEA 2, the fuel can evenly be supplied to the MEA 2. That is, the distribution of fuel over the surface of the fuel electrode 13 can be made equal, and accordingly the minimum amount of fuel required to initiate the power generating reaction in the MEA 2 can be supplied throughout the MEA 2. This makes it possible to efficiently cause a power generating reaction in the MEA 2 without increasing the size of the fuel cell 1 or complicating the fuel cell 1. This improves output of the fuel cell 1.

In the fuel distribution mechanism 3 used in the present embodiment, liquid fuel is distributed to the plurality of fuel outlets 27a from the introduction tube 20 disposed in the mechanism 3. Strictly speaking, this brings about the phenomenon in which the temperature of the liquid fuel near the fuel inlet 31 is slightly high and decreases as the liquid fuel flows to a deeper place.

The liquid fuel 41 introduced to the fuel distribution mechanism 3 from the fuel inlet 31 is led to the plurality of fuel outlets 27a via the upstream fuel passages 21 and branch passages 22 to 27. By use of the fuel distribution mechanism 3 with such a structure, the liquid fuel 41 injected into the fuel distribution mechanism 3 from the fuel inlet 31 can be evenly distributed to the plurality of fuel outlets 27a regardless of the directions and positions thereof. This further enhances uniformity of the power generating reaction in the surface of the MEA 2.

Further, connecting the fuel inlet 31 and the plurality of fuel outlets 27a by means of the introduction tube 20, upstream fuel passages 21, and branch passages 22 to 27, allows a design that enables supply of more fuel to specific areas of the fuel cell 1. For example, when heat dissipates from a half of the fuel cell 1 due to the mounting position of a device, conventional fuel cells suffer from scattering of temperature and accordingly cannot avoid degradation in average output. To prevent this, the pattern of the branch passages 22 to 27 is adjusted such that the fuel outlets 27a are densely arranged in advance in an area where heat dissipation is significant. Thereby, heat generated by power generation in the area can be increased. This makes the degree of power generation in the surface of the MEA 2 uniform and suppresses any decrease in output.

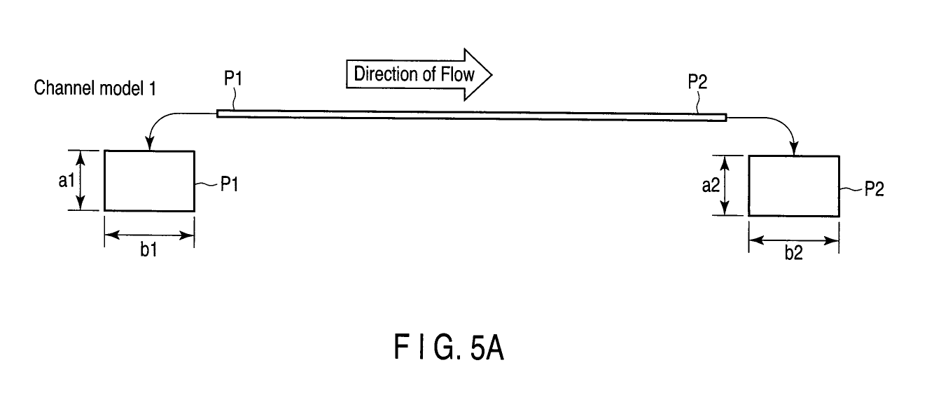

FIG. 4 is a characteristic diagram showing the result of a pressure loss comparison between the fuel cell with the branch passages according to Example 1 and the fuel cell in Comparative Example, which are shown in the Table 1. In the diagram, a horizontal axis represents tube length L (mm) and a vertical axis represents pressure P (relative value). The characteristic lines A and B in the diagram represent the results of Example 1 and Comparative Example, respectively. Pressure P on the vertical axis is represented by a relative pressure that has, as a reference value (=1), the pressure of the fuel inlet 31 just after fuel has been supplied by a pump.

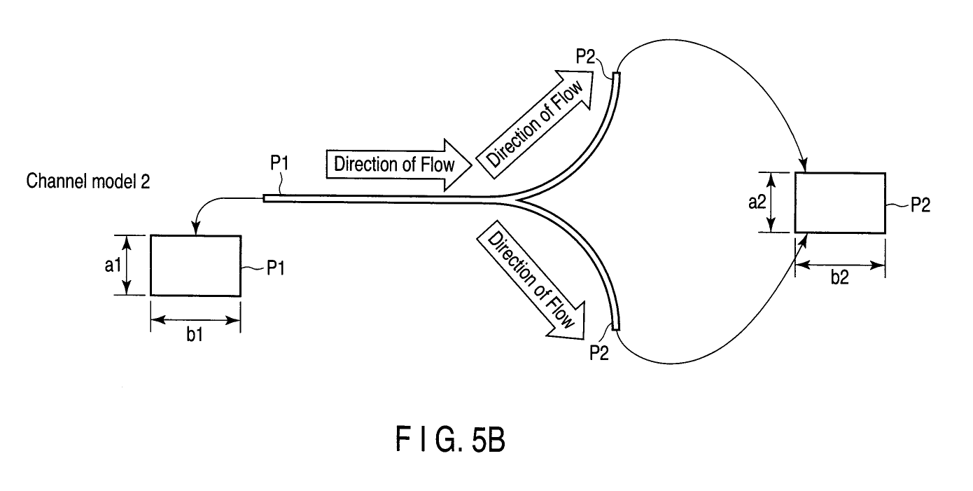

FIGS. 5A and 5B illustrate the concept 1 of a passage that does not branch and the concept 2 of a passage that branches, respectively. The result shown in FIG. 4 is obtained by a simulation based on the passage concepts 1 and 2 as shown in FIGS. 5A and 5B. Preconditions are set as follows: flow rate Qin is 0.5 μl/mm (flow rate in one fuel outlet), the outlet pressure Pout is zero in terms of relative pressure, and the entire tube length “L” is 100 mm.

As is apparent from FIG. 4, loss of pressure in Example 1 is significantly reduced compared to that in Comparative Example, and Example 1 can reduce pump backpressure by two digits (i.e., to one hundredth or less). Such findings are sufficient to ensure the practical use of a semi-passive system fuel cell that utilizes an electro-osmotic flow pump (EO pump) as described in USP-A Publication No. 2006/0029851A1. As for the passive system fuel cell, its description will be given below. In addition, an improvement in the flow of liquid fuel in the fuel distribution mechanism has the merit that blockages caused by air bubbles are prevented.

Next, a semi-passive system fuel cell will be described.

A pump is attached to the supply channel 5 between the fuel storage part 4 and the fuel distribution mechanism 3. This makes it possible to transport liquid fuel more efficiently with the aid of the pump drive force as well as capillary force. The pump type is not limited in particular. However, in order to convey a small quantity of liquid fuel under satisfactory control and reduce the size and weight of the fuel cell, it is preferable to use an electro-osmotic flow pump (EO pump), rotary pump (rotary vane pump), diaphragm pump, squeeze pump, or the like. The electro-osmotic flow pump uses a sintered porous body, such as silica, which causes electro-osmotic flow. The electro-osmotic flow pump is described in Patent Document 2 mentioned above. The rotary pump rotates a vane by means of a motor, thereby feeding a liquid. The diaphragm pump feeds liquid by driving a diaphragm by means of an electromagnet or piezoelectric ceramics. The squeeze pump presses part of a flexible fuel passage and squeezes and thus feeds fuel. Among these pumps, the electro-osmotic flow pump and the diaphragm pump with piezoelectric ceramics are preferable from the viewpoint of driving power, size, etc.

Since the fuel cell 1 is to be used in a small electronic apparatus, it is preferable that the quantity of liquid fuel fed by the pump be from 10 μL/min to 1 mL/min. If the quantity of fuel fed exceeds 1 mL/min at any one time, it is too large. This may result in significant variation in the quantity of fuel supplied to the MEA 2, leading to a large change in output. In order to prevent this, a reservoir may be provided between the pump and the fuel distribution mechanism 3. However, such a configuration is insufficient to suppress all change in the quantity of fuel supplied to the MEA 2, and on the other hand increases the size of the device.

If the quantity of liquid fuel fed by the pump is less than 10 μL/min, it may not be sufficient when fuel consumption increases as in the start of the apparatus. This may degrade, for example, the starting characteristics of the fuel cell 1. From this and the above point of view, it is preferable to use a pump that has the ability to feed liquid at from 10 μL/min to 1 mL/min. Furthermore, it is preferable that the quantity of liquid fed by the pump be from 10 to 200 μL/min. In order to stably feed such a quantity of liquid, it is preferable to use a pump such as an electro-osmotic flow pump or diaphragm pump.

In addition, a liquid fuel impregnated layer may be laid on the inside of the fuel distribution mechanism 3. Preferable examples of the liquid fuel impregnated layer are porous fiber such as porous polyester fiber or porous olefin resin, or porous resin of continuous foam. Even when liquid fuel in the fuel storage part decreases or the main body of the fuel cell is placed at an angle, resulting in uneven fuel supply, this liquid fuel impregnated layer enables liquid fuel to be evenly supplied to a gas-liquid separation film, not shown. Consequently, evenly vaporized liquid fuel can be supplied to the fuel electrode catalyst layer 11. Instead of polyester fiber, the liquid fuel impregnated layer may be formed from various water-absorbent polymers such as acrylic acid resin. Alternatively, the liquid fuel impregnated layer may be formed from a material such as sponge or a mass of fibers, which is able to hold a liquid by osmosis. This liquid fuel impregnated part is effective in supplying a suitable quantity of fuel regardless of the position of the main body.

The liquid fuel is not limited to methanol. It may be, for example, an ethanol fuel such as ethanol solution or pure methanol, a propanol fuel such as propanol solution or pure propanol, a glycol fuel such as glycol solution or pure glycol, dimethyl ether, formic acid, or other liquid fuel. That is, any liquid fuel suitable for a fuel cell can be used. However, a methanol solution or pure methanol liquid with a fuel concentration of 80 mol % or more is preferable.

The mechanism for feeding liquid fuel from the fuel storage part 4 to the fuel distribution mechanism 3 is not limited in particular. For example, where the installation place for use is fixed, liquid fuel may be gravity fed from the fuel storage part 4 to the fuel distribution mechanism 3. Alternatively, liquid fuel can be fed from the fuel storage part 4 to the fuel distribution mechanism 3 by capillary force by using the supply channel 5 filled with a porous body or the like. In the configuration in which fuel is supplied from the fuel distribution mechanism 3 to the MEA 2, a fuel cutout valve may be disposed instead of the pump. In this case, the fuel cutout valve is used to control liquid fuel supplied through the passages. Furthermore, in order to enhance the stability and reliability of the fuel cell, the fuel cutout valve may be disposed in series with the pump.

However, when the cutout valve is installed in the supply channel 5 between the pump and the fuel storage part 4, fuel in the pump may evaporate due to, for example, long storage. This may adversely affect the function of sucking liquid fuel from the fuel storage part 4. For such a reason, it is preferable to install the cutout valve in the supply channel 5 between the pump and the fuel distribution mechanism 3, thereby preventing evaporation of liquid fuel from the pump 31 when the fuel cell is stored for a long time.

Insertion of the cutout valve between the fuel storage part 4 and the fuel distribution mechanism 3 makes it possible to avoid, for example, inevitable consumption of a minute quantity of fuel when the fuel cell 1 is not used, or sucking failure when the pump is operated again. These greatly contribute to improvement in the practical usability of the fuel cell 1.

### Second Embodiment

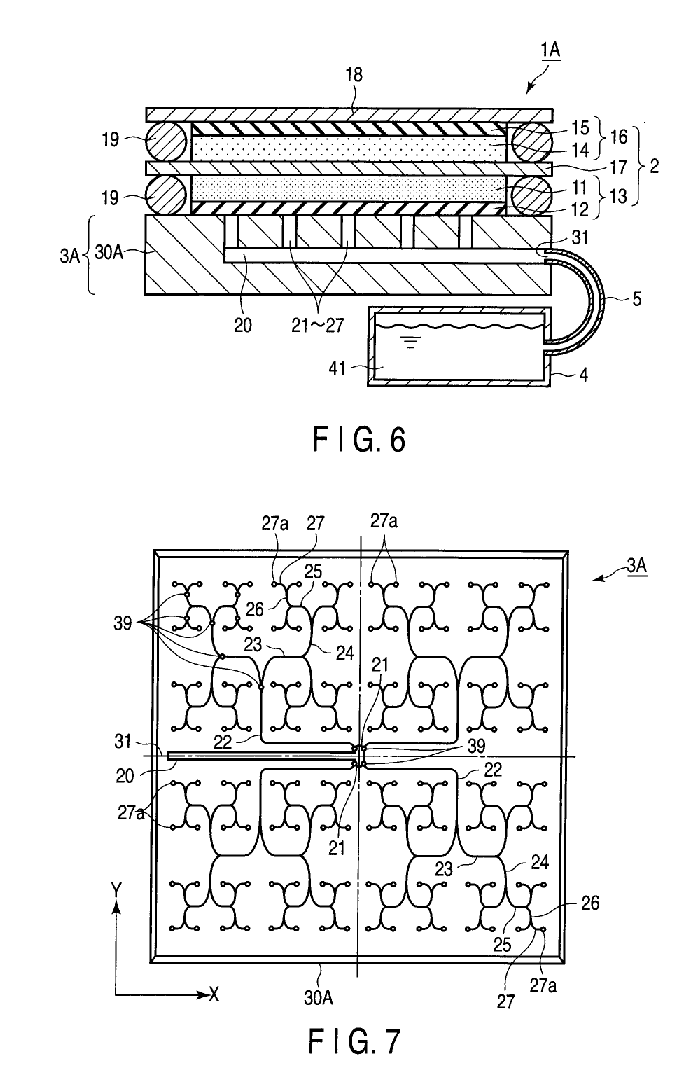

Referring to FIGS. 6 to 12, the second embodiment will next be described. Explanations of parts identical to those in the first embodiment are omitted.

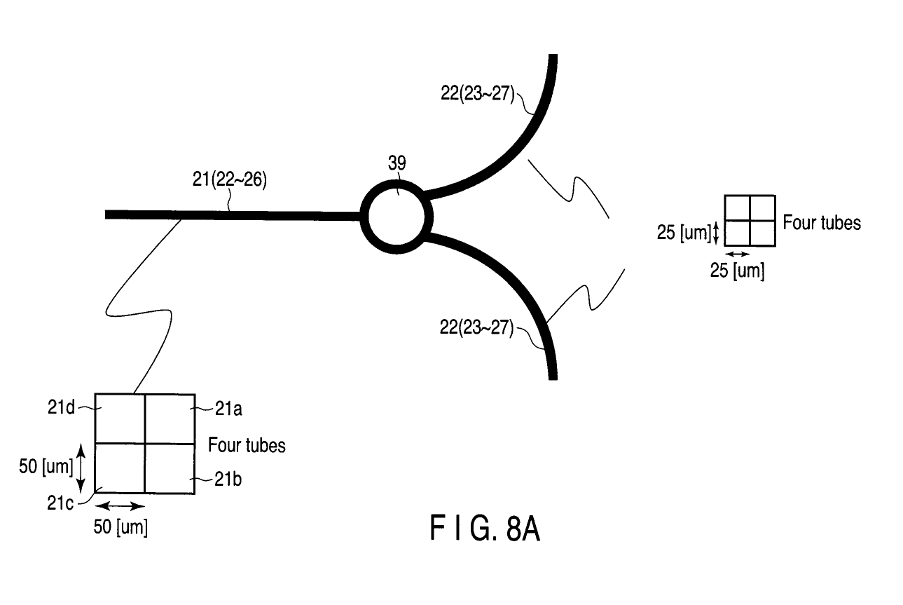

As shown in FIG. 6, a fuel cell 1A according to the present embodiment comprises a fuel distribution mechanism 3A different from that of the fuel cell 1 in the first embodiment. As shown in FIG. 7, the fuel cell distribution mechanism 3A comprises a distribution plate 30A. The distribution plate 30A comprises: one fuel inlet 31; a plurality of fuel outlets 27a for discharging fuel toward an anode 13; and fuel passages 20 to 27 communicating with one another in order to circulate fuel from the fuel inlet 31 to the fuel outlets. The fuel passage comprises: an introduction tube 20 communicating with the fuel inlet 31; upstream fuel passages 21 communicating with the introduction tube 20; and first to sixth branch passages 22 to 27 diverging one after another in sequence from the upstream fuel passages 21. The fuel inlet 31 communicates with one end (leading end) of the introduction tube 20. The introduction tube 20 is formed from a thin tube of rectangular cross-section with a uniform diameter (e.g., an equivalent inside diameter of 0.05 to 5 mm). The introduction tube 20 serves as a header that distributes liquid fuel to the fuel passages 21 to 27 continuous with this introduction tube 20. In the present embodiment, only one fuel inlet 31 is provided but fuel can be injected to the fuel distribution mechanism 3A from two or more fuel inlets. When fuel is injected from the plurality of fuel inlets, it is preferable to evenly dispose the fuel inlets relative to each MEA 2, taking into account the arrangement of MEA 2.

From the inlet tube 20, the four upstream fuel passages 21 diverge. From each upstream fuel passage 21, the two first branch 22 passages diverge. From each first branch passage 22, the two second branch passages 23 diverge. From each second branch passage 23, the two third branch passages 24 diverge. From each third branch passage 24, the two fourth branch passages 25 diverge. From each fourth branch passage 25, the two fifth branch passages 26 diverge. From each fifth branch passage 26, the two sixth branch passages 27 diverge. The total number of the sixth branch passages 27 located in the rearmost positions is 128, and a fuel outlet 27a is open at the trailing end of each sixth branch passage 27. All these fuel outlets 27a are oriented in the direction of the fuel electrode 13 of the MEA 2.

Bypass holes (ports) 39 for dividing each fuel passage into a plurality of branch passages are formed at: a branch point from which each upstream fuel passage 21 diverges into the first branch passages 22; a branch point from which each first branch passage 22 diverges into the second branch passages 23; a branch point from which each second branch passage 23 diverges into the third branch passages 24; a branch point from which each third branch passage 24 diverges into the fourth branch passages 25; a branch point from which each fourth branch passage 25 diverges into the fifth branch passages 26; and a branch point from which each fifth branch passage 26 diverges into the sixth branch passages 27. These bypass holes 39 enable, for example, vertical communication among the fuel passages 21 to 27 arranged in layers in the distribution plate 30A of the fuel distribution mechanism 3A, as described below, and thereby greatly contribute to the uniform supply of fuel to a large number of fuel outlets 27a.

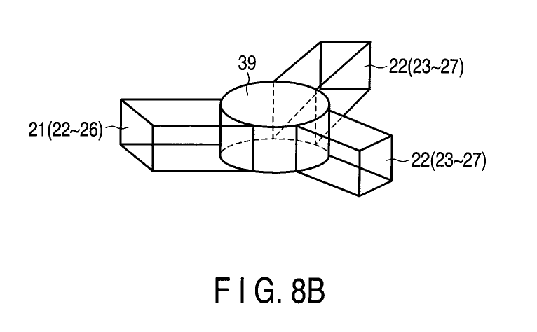

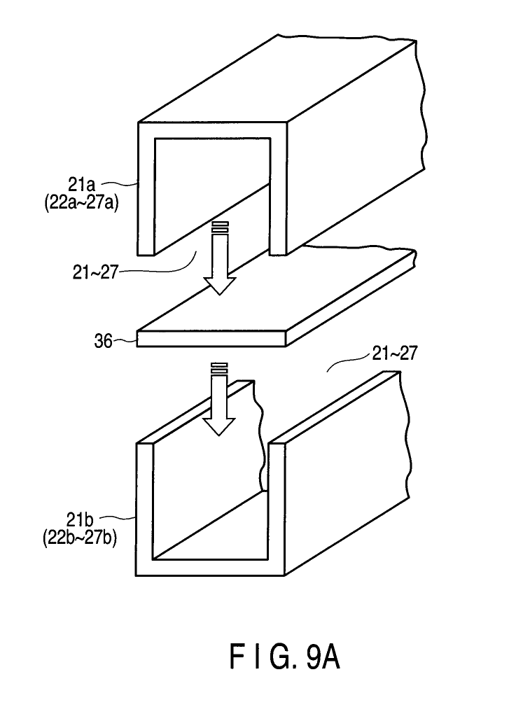

The distribution plate of the fuel distribution mechanism, in particular, the branch passages and bypass holes will now be described in detail with reference to FIGS. 8A, 8B, 9A, and 9B.

A large number of rectangular cross-sectional branch passages separated by vertical walls and horizontal walls are formed in the distribution plate 30A. For example, as shown in FIG. 8A, the branch passages forming each upstream fuel passage 21 are arranged in two layers, upper and lower, such that the upper layer is formed from the branch passages 21a and 21d arranged in two rows and the lower layer is formed from the branch passages 21b and 21c arranged in two rows. The size of each of the branch passages 21a to 21d is, for example, 50-μm height×50-μm width. The horizontal wall (XY wall) of each of the layered fuel passages is formed by inserting a partition wall 36 between a pair of micro-channel members 21a and 21b, one upper and one lower, as shown in FIG. 9A, and by joining them together with an adhesive or the like. Further, a vertical wall (ZX or ZY wall) separating the adjacent fuel passages is patterned using photolithography, and micro-channels 21d and 21c are formed in a similar manner. The micro-channel members 21a to 21d and partition walls 36 are made of resin, such as polyethylene (PE), which excels in contact compatibility with liquid fuel 41 and can be pattern-etched.

These four separated branch passages 21a to 21d communicate with the first branch passages 22 each of which diverges in a downstream direction into the two branch passages at the bypass hole 39 serving as their branch point, as shown in FIG. 8B. Furthermore, the inside of each of the first branch passages 22 is divided into branch passages (not shown) arranged in two rows and two columns in the same manner as the upstream fuel passages 21. The size of each of the branch passages 22a to 22d of each branch passage 22 is, for example, 25-μm height×25-μm width. The equivalent diameter of each branch passage 22 gradually decreases in such a manner. Similarly, each of the first branch passages 22 communicates with the two separate second branch passages 23 via the bypass hole 39 at a further downstream branch point. Furthermore, the inside of each of the second branch passages 23 is divided into branch passages (not shown) arranged in two rows and two columns. Similarly, each of the second branch passages 23 communicates with the two separate third branch passages 24 via the bypass hole 39 at a further downstream branch point. Furthermore, the inside of each of the third branch passages 24 is divided into branch passages (not shown) arranged in two rows and two columns. Similarly, each of the third branch passages 24 communicates with the two separate fourth branch passages 25 via the bypass hole 39 at a further downstream branch point. Furthermore, the inside of each of the fourth branch passages 25 is divided into branch passages (not shown) arranged in two rows and two columns. Similarly, each of the fourth branch passages 25 communicates with the two separate fifth branch passages 26 via the bypass hole 39 at a further downstream branch point. Furthermore, the inside of each of the fifth branch passages 26 is divided into branch passages (not shown) arranged in two rows and two columns. Similarly, each of the fifth branch passages 26 communicates with the two separate sixth branch passages 27 via the bypass hole 39 at a further downstream branch point. Furthermore, the inside of each of the sixth branch passages 27 is divided into branch passages (not shown) arranged in two rows and two columns. The total number of the sixth branch passages 27 located furthest downstream is 128, and they communicate with the corresponding 128 fuel outlets 27a at their trailing ends. All these fuel outlets 27a are open opposite the anode 13 of the MEA 2.

The plurality of fuel outlets 27a are disposed in a surface of the distribution plate 30A opposite the anode 13 so that fuel can be evenly supplied throughout the MEA 2. In the four-series connection, the number of fuel outlets 27a may be four or more. However, in order to evenly supply fuel into the surface of the MEA 2, it is preferable that one or more fuel outlets 27a be present per cm². Less than one fuel outlet 27a per cm² cannot supply fuel to the MEA 2 sufficiently evenly.

A method for manufacturing the distribution plate 30A for the fuel distribution mechanism 3A according to the present embodiment will be briefly described next.

Three resin plates (PE plates) of different thickness are prepared. Two of them are thick and one of them is thin. Using a pattern etching that adopts a photolithography method, vertical walls and bypass holes 39 are formed on one side of each of the two thick plates, the vertical walls being used to define first to sixth branch passages 22 to 27 and upstream fuel passages 21 so that the micro-channel members 21a and 21d are formed on one thick plate and the micro-channel members 21b and 21c are formed on the other thick plate.

On the other hand, the one thin plate is used as a partition wall 36.

As shown in FIG. 9A, the partition wall 36 is inserted between a pair of micro-channel members 21a and 21b and between a pair of micro-channel members 21d and 21c, and they are joined together with an adhesive. The three resin plates are integrated by the adhesion. The periphery of the pre-molding is trimmed and any burrs are removed from fuel outlets 27a. Thus, a desired distribution plate 30A is obtained. The supply channel 5 extending from the fuel storage part 4 is connected to the fuel inlet 31 formed in the thus manufactured distribution plate 30A. Furthermore, a cover plate 18 and the MEA 2 are combined with this, thereby obtaining a desired fuel cell 1. A method for manufacturing such a micro-channel passage may use a method described as in Jpn. Pat. Appln. KOKAI Publication No. 2006-181740.

Incidentally, as shown in FIG. 9B, a distribution plate of a conventional device is formed by joining one partition plate 102 to one micro-channel member 101 that has a micro-channel passage 103 pattern formed therein with an adhesive.

A liquid fuel circulates within the fuel cell 1A in the manner described below.

The liquid fuel introduced into the distribution plate 30A from the fuel inlet 31 flows through the upstream fuel passages 21 from the introduction tube 20 and is led to a plurality of fuel outlets 27a via the first to sixth branch passages 22 to 27 diverging one after another. At this time, the liquid fuel 41 is passed through the bypass holes 39 at the branch points formed in the upstream fuel passages 21 to the first to sixth branch passages 22 to 27 and is dispersed by the branch passages. Accordingly, even if air bubbles enter any fuel passages and block, for example, one of the branch passages, the fuel can be circulated by the other branch passages. This mitigates air bubble blockage of any fuel passage and, by the time the liquid fuel 41 reaches the fuel outlets 27a, makes the supply pressure of the liquid fuel 41 uniform. Thus, the liquid fuel 41 can be stably supplied to each fuel outlet 27a.

Disposed in the plurality of fuel outlets 27 are, for example, gas-liquid separation films (not shown), which pass vaporized components of a liquid fuel but do not pass the liquid components thereof. Accordingly, only the vaporized components of the liquid fuel are passed through the film and supplied to the anode 13 of the MEA 2. That is, the vaporized components of the liquid fuel are emitted toward a plurality of areas of the anode 13 from the plurality of fuel outlets 27a. Each of the gas-liquid separation films has the property of permitting only the vaporized components of a liquid fuel (e.g., a methanol solution) to pass through, blocking passage of the liquid fuel itself. As such a gas-liquid separation film, a porous film such as silicon sheet or polyethylene terephthalate (PTFE) film is used. In this case, when liquid methanol is used as a fuel liquid, the vaporized component of the liquid fuel is vaporized methanol. When a methanol solution is used as liquid fuel, the vaporized component thereof is a gas mixture, which contains the vaporized component of the methanol and a vaporized component of water.

The fuel emitted from the fuel distribution mechanism 3 is supplied to the anode 13 of the MEA 2 as described above. Within the MEA 2, the fuel is diffused by the anode gas diffusion layer 12 and supplied to an anode catalyst layer 11. When methanol fuel is used as the liquid fuel, an internal reforming reaction of methanol, described by the formula (1) below, occurs in the anode catalyst layer 11. When pure methanol is used as the liquid fuel, water produced in a cathode catalyst layer 14 or water in the electrolyte membrane 17 reacts with methanol to cause the internal reforming reaction described in the formula (1). Alternatively, the internal reforming reaction is initiated using another reaction mechanism that does not require water.

An electron (e⁻) produced by the reaction is led to the outside via the current collector, and further led to the cathode 16 after being used as electricity to operate a mobile electronic apparatus or the like. A proton (H⁺) produced in the internal reforming reaction described in the formula (1) is led to the cathode 16 via the electrolyte membrane 17. Air is supplied to the cathode 16 as an oxidizing agent. An electron (e⁻) and a proton (H⁺) that have reached the cathode 16 react with oxygen in air in the cathode catalyst layer 14 according to formula (2) described below, yielding water as a result of the reaction.

Since the plurality of fuel outlets 27a are arranged so that fuel can be supplied along the entire plane of the MEA 2, the fuel can be uniformly supplied to the MEA 2. That is, the fuel is equally distributed within the plane of the anode 13. Accordingly, the fuel required for a power generating reaction in the MEA 2 can be sufficiently supplied throughout the MEA 2. This enables the efficient initiation of a power generating reaction in the MEA 2 without complicating or increasing the size of the fuel cell 1. This improves the output of the fuel cell 1. In other words, the output and stability of the fuel cell 1 can be improved without degrading the advantages of a passive system fuel cell 1 that does not circulate fuel.

Using the fuel distribution mechanism 3 with such a structure enables liquid fuel injected into the fuel distribution mechanism 3 from the fuel inlet 31 to be distributed to the fuel outlets 27a evenly regardless of the outlet directions or positions. This further enhances the uniformity of power generating reaction within the surface of the MEA 2.

The liquid fuel 41 is not limited to methanol. It may be, for example, an ethanol fuel such as ethanol solution or pure methanol, a propanol fuel such as propanol solution or pure propanol, a glycol fuel such as glycol solution or pure glycol, dimethyl ether, formic acid, or other liquid fuel. That is, any liquid fuel suitable for a fuel cell can be used. However, a methanol solution or pure methanol liquid with a fuel concentration of 80 mol % or more is preferable.

### Example

Referring to the drawings and Table 2, Example of the present invention will now be described while comparing it with Comparative Example.

### Example

The present Example uses a fuel distribution mechanism 3 that has the same disposition of the fuel passages 20 to 27 shown in FIG. 7. An introduction tube 20 has a square cross-section of 400-μm height×400-μm width×400-μm length. The inside of each upstream fuel passage 21 is partitioned into four branch passages 21a to 21d, as shown by (a) in FIG. 3 and the Table 1, so as to have a cylindrical section with a diameter of 100 μm and a length of 45 mm.

The first branch passage 22 is 25 mm long and has a rectangular cross-section whose height “a” is 50 μm and width “b” is 800 μm. The second branch passage 23 is 14 mm long and has a rectangular cross-section whose height “a” is 50 μm and width b is 400 μm. The third branch passage 24 is 5 mm long and has a rectangular cross-section whose height “a” is 50 μm and width “b” is 200 μm. The fourth branch passage 25 is 6 mm long and has a rectangular cross-section whose height “a” is 50 μm and width “b” is 100 μm. The fifth branch passage 26 is 2 mm long and has a square cross-section whose height “a” is 50 μm and width “b” is 50 μm. The sixth branch passage 27 is 3 mm long and has a rectangular cross-section whose height “a” is 50 μm and width “b” is 25 μm. Each of the branch passages 22 to 27 is partitioned into four branch passages. The height and width of each of the branch passages are half the height and width of the branch passage. As described above, the first to sixth branch passages 22 to 27 other than the upstream fuel passage 21 have the same height “a” (=50 μm) due to the manufacturing process (described below). The total length from the fuel inlet 31 to the fuel outlet 27a is about 100 mm.

In the fuel cell according to the present Example, the fuel passages 21 to 27 are formed from four branch passages, as described above. A liquid fuel 41 is introduced to a fuel distribution mechanism 3A from a fuel inlet 31 through a supply channel 5. In the fuel distribution mechanism 3A, the liquid fuel 41 flows into the introduction tube 20 formed from a straight narrow tube. This liquid fuel 41 then flows through the four upstream fuel passages 21 diverging in sequence from the introduction tube 20 and through branch points provided in the first to sixth branch passages 22 to 27. The liquid fluid 41 is thereby distributed almost uniformly, and finally supplied to a fuel electrode 13 for an MEA 2 from the fuel outlets 27a located in 128 areas communicating with the trailing ends of the sixth branch passages 27.

The introduction tube 20 and upstream fuel passages 21 function as headers. Therefore, the liquid fuel 41 of predetermined concentration is discharged from each of the fuel outlets 27a. In addition, since the plurality of fuel outlets 27a are arranged so that fuel is supplied to the entire surface of the MEA 2, the fuel can evenly be supplied to the MEA 2. That is, the distribution of fuel over the surface of the fuel electrode 13 can be made equal, and accordingly the minimum amount of fuel required to initiate the power generating reaction in the MEA 2 can be supplied throughout the MEA 2. This makes it possible to efficiently cause a power generating reaction in the MEA 2 without increasing the size of the fuel cell 1 or complicating the fuel cell 1. This improves output of the fuel cell 1.

The fuel distribution mechanism 3A used in the present Example distributes a liquid fuel to the plurality of fuel outlets 27a from the introduction tube 20 disposed within the fuel distribution mechanism 3A.

The fuel liquid 41 introduced to the fuel distribution mechanism 3A from the fuel inlet 31 is led to the plurality of fuel outlets 27a via the upstream fuel passages 21 and branch passages 22 to 27, which diverge one after another. Using the fuel distribution mechanism 3A with such a structure enables the liquid fuel 41 injected into the fuel distribution mechanism 3A from the fuel inlet 31 to be distributed to the fuel outlets 27a uniformly regardless of outlet direction or position. This, furthermore, enhances the uniformity of power generating reaction within the surface of the MEA 2.

Furthermore, connecting the fuel inlet 31 and the plurality of fuel outlets 27a by means of the upstream fuel passages 21 and branch passages 22 to 27 via the branch points allows the supply of more fuel to specific areas of the fuel cell 1A. For example, when heat dissipates from a half of the fuel cell 1A due to the mounting position of a device, conventional fuel cells suffer from scattering of temperature and accordingly cannot avoid degradation in average output. To prevent this, the pattern of the branch passages 22 to 27 and branch points is adjusted such that the fuel outlets 27a are densely arranged in advance in an area where heat dissipation is significant. Thereby, heat generated by power generation in the area can be increased. This makes the degree of power generation in the surface of the MEA 2 uniform and suppresses any decrease in output.

### Comparative Example

As Comparative Example, a distribution plate in which branch passages 21 to 27 are not divided into branch passages, that is, a distribution plate formed from one passage is manufactured. As in Example, the Comparative Example uses a fuel distribution mechanism 3 that has the same disposition of the fuel passages 20 to 27 shown in FIG. 7. An introduction tube 20 has a square cross-section of 400 μm height×400 μm width×45 μm length.

The first branch passage 22 is 25 mm long and has a rectangular cross-section whose height “a” is 50 μm and width “b” is 800 μm. The second branch passage 23 is 14 mm long and has a rectangular cross-section whose height “a” is 50 μm and width “b” is 400 μm. The third branch passage 24 is 5 mm long and has a rectangular cross-section whose height “a” is 50 μm and width “b” is 200 μm. The fourth branch passage 25 is 6 mm long and has a rectangular cross-section whose height “a” is 50 μm and width “b” is 10 μm. The fifth branch passage 26 is 2 mm long and has a square cross-section whose height “a” is 50 μm and width “b” is 50 μm. The sixth branch passage 27 is 3 mm long and has a rectangular cross-section whose height “a” is 50 μm and width “b” is 2.5 μm. The total length from the fuel inlet 31 to the fuel outlet 27a is about 100 mm.

Table 2 shows the number of branch passages of the branch passages 21, as representative branch passages, in Example and Comparative Example, the number of junctions of the convergent passages, and the disposition configuration of the distribution plate 30.

Except for their dimensions, the other branch passages are the same as branch passages 21.

TABLE 2

| | Tube dimension | | The | The | The |
|---|---|---|---|---|---|
| | (μm) | | number of | number of | number of |
| | Length | Width | passages | junctions | layers |
| Example | 50 | 50 | 4 | 4 | 2 |
| Comparative | 100 | 100 | 1 | 0 | 1 |
| Example | | | | | |

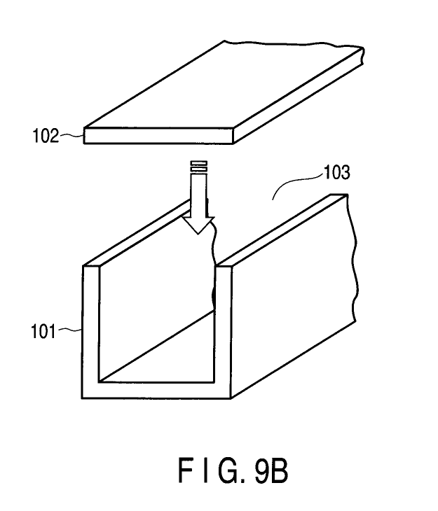

FIG. 10 is a characteristic diagram showing the result of a change in fuel flow rate in the fuel cell according to Example and in that according to Comparative Example. In the diagram, the horizontal axis indicates time that has elapsed from the initialization of fuel supply and the vertical axis indicates a flow rate (relative value) in each fuel outlet 27. The characteristic lines A and B in the diagram represent the results of Example and Comparative Example, respectively. The flow rate on the vertical axis of the diagram is expressed using the relative flow rate, in which a reference value (=1) is assigned for the flow rate when fuel supply is initiated.

As a result, whereas the fuel cell in the present invention does not show any change in the flow rate in the fuel outlets even when the fuel supply time elapses, the flow rate in the fuel supply port of the fuel cell in Comparative Example decreases as the fuel supply time elapses, finally resulting in a cessation of the supply of the fuel. Accordingly, even if air bubbles enter any fuel passages and block, for example, one of the branch passages, the fuel cell in the present invention circulates the fuel by means of the other branch passages. This mitigates air bubble blockage of any fuel passage and ensures a stable supply of fuel to the fuel outlets. In contrast, since the fuel cell in Comparative Example is formed from one branch passage that has no branch passages, it cannot supply fuel downstream if an air bubble blocks any area of the fuel passage.

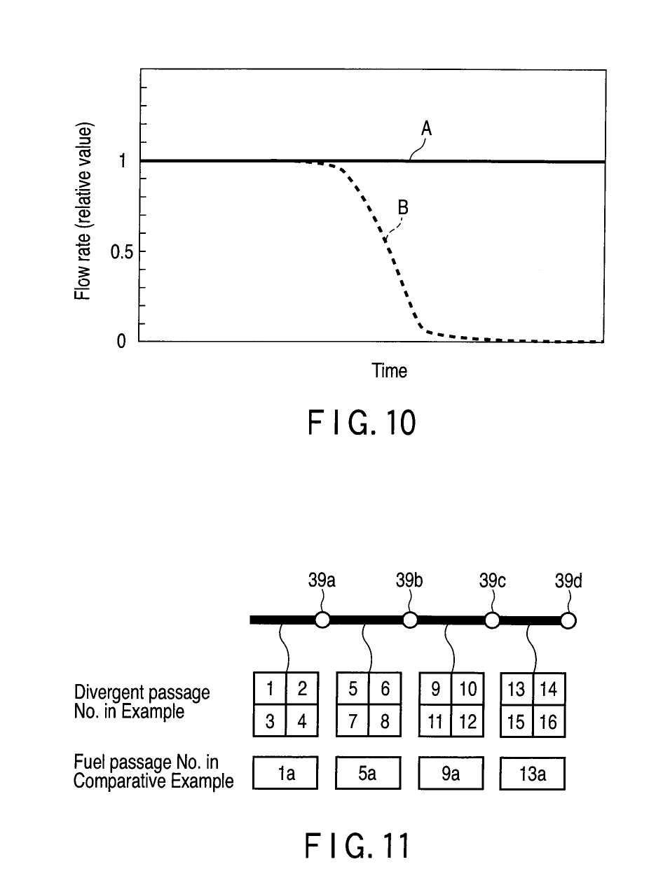

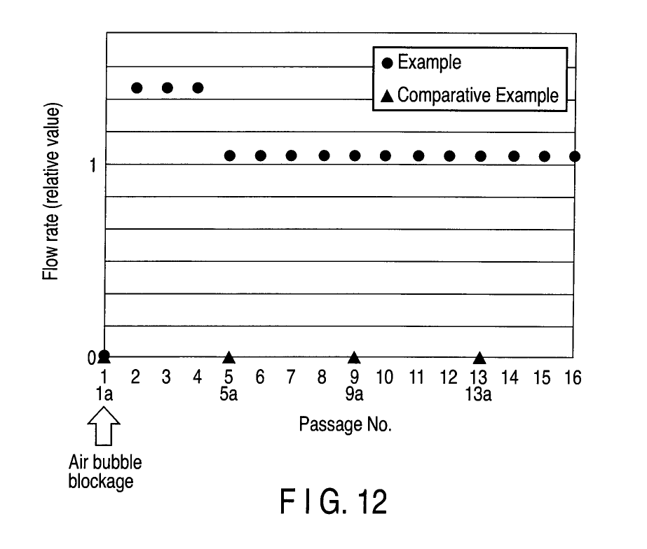

A schematic explanation for this will be given with reference to FIGS. 11 and 12.

FIG. 11 shows a fuel passage comprising four branch points 39a to 39d. Four passages diverge from a bypass hole between the adjacent branch points. Specifically, the branch point 39a is a formed between the branch passages Nos. 1 to 4 and the branch passages Nos. 5 and 8; the branch point 39b, between the branch passages Nos. 5 to 8 and the branch passages Nos. 9 to 12; the branch point 39c, between the branch passages Nos. 9 to 12 and the branch passages Nos. 13 to 16.

The length of branch passages Nos. 1 to 16 are equal and define equal pitch intervals. A liquid fuel flows from the branch passages Nos. 1 to 4 toward the branch passages Nos. 13 to 16.

FIG. 12 is a characteristic diagram showing the results of the fuel cell in Example and a fuel cell in Comparative Example, which are shown in FIG. 11, the fuel cell in Comparative Example not being divided into branch passages, that is, this fuel cell being formed with only one fuel passage. In the diagram, a horizontal axis indicates the passage numbers, and a vertical axis indicates flow rate (relative value) in each branch passage.

Black circular plots and black triangular plots in the diagram represent the results of Example and Comparative Example, respectively.

As is apparent from this diagram, even if a blockage (zero flow rate) in the branch passage No. 1 occurs in the fuel passage, the configuration of Example compensates by means of the other branch passages Nos. 2 and 4, and stably supplies fuel without affecting the downstream branch passages. In contrast, if a blockage (zero flow rate) in the branch passage 1a occurs, the configuration of Comparative Example cannot supply the fuel downstream (zero flow rate) since it has no passages to compensate for the blocked one.

Next will be described a semi-passive system fuel cell that uses a pump to supply a fuel to a fuel distribution mechanism. Explanations of the fuel cell in the present embodiment which are the same as those in above description will be omitted.

A pump 42 is attached to the supply channel 5 between the fuel storage part 4 and the fuel distribution mechanism 3A. This makes it possible to transport liquid fuel more efficiently with the aid of the pump drive force as well as capillary force. The type of the pump 42 is not limited in particular. However, in order to convey a small quantity of liquid fuel under satisfactory control and reduce the size and weight of the fuel cell, it is preferable to use an electro-osmotic flow pump (EO pump), rotary pump (rotary vane pump), diaphragm pump, squeeze pump, or the like. The electro-osmotic flow pump uses a sintered porous body, such as silica, which causes electro-osmotic flow. The electro-osmotic flow pump is described in Patent Document 2 mentioned above. The rotary pump rotates a vane by means of a motor, thereby feeding a liquid. The diaphragm pump feeds liquid by driving a diaphragm by means of an electromagnet or piezoelectric ceramics. The squeeze pump presses part of a flexible fuel passage and squeezes and thus feeds fuel. Among these pumps, the electro-osmotic flow pump and the diaphragm pump with piezoelectric ceramics are preferable from the viewpoint of driving power, size, etc.

The present invention applied to a semi-passive system fuel cell that uses a pump such as the pump 42 can reduce load on the pump where a fuel passage is blocked and fuel cannot be supplied downstream.

In addition, a liquid fuel impregnated layer (not shown) may be laid on the inside of the fuel distribution mechanism 3. Preferable examples of the liquid fuel impregnated layer include porous fiber such as porous polyester fiber or porous olefin resin, or porous resin of continuous foam. Even when liquid fuel in the fuel storage part decreases or the main body of the fuel cell is placed at an angle, resulting in uneven fuel supply, this liquid fuel impregnated layer enables liquid fuel to be evenly supplied to a gas-liquid separation film, not shown. Consequently, evenly vaporized liquid fuel can be supplied to the fuel electrode catalyst layer 11. Instead of polyester fiber, the liquid fuel impregnated layer may be formed from various water-absorbent polymers such as acrylic acid resin. Alternatively, the liquid fuel impregnated layer may be formed from a material such as sponge or a mass of fibers, which is able to hold a liquid by osmosis. This liquid fuel impregnated part is effective in supplying a suitable quantity of fuel regardless of the position of the main body.

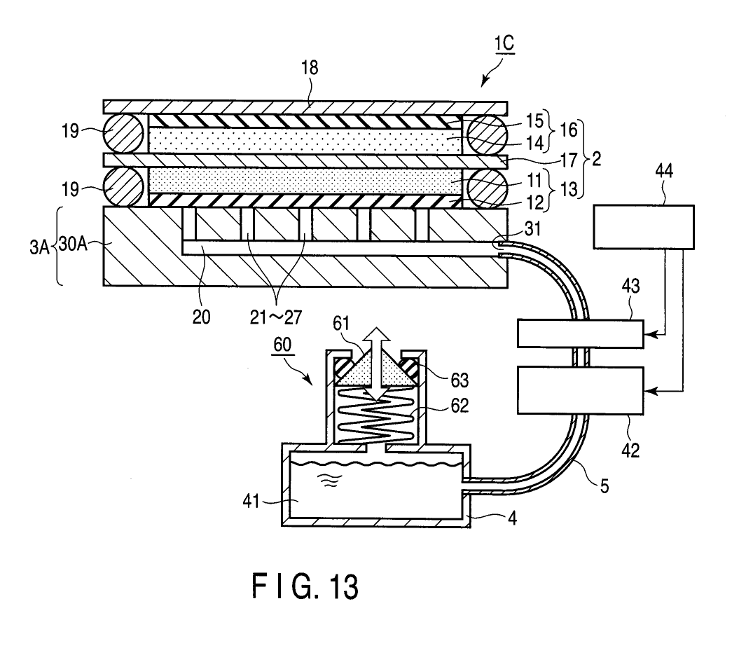

Furthermore, in order to improve the stability and reliability of the fuel cell, it is preferable to dispose a fuel cutout valve 42 in series with the pump 42. The fuel cell 1C shown in FIG. 13 has a structure in which the fuel cutout valve 43 is inserted into the supply channel 5 extending between the pump 42 and the fuel distribution mechanism 11. Even when the fuel cutout valve 43 is disposed between the pump 42 and the fuel storage part 4, the function of the fuel cell is not adversely affected.

However, when the fuel cutout valve 43 is installed in the supply channel 5 between the pump 42 and the fuel storage part 4, fuel in the pump 42 may evaporate due to, for example, long storage. This may adversely affect the function of sucking liquid fuel from the fuel storage part 4. For such a reason, it is preferable to install the fuel cutout valve 43 in the supply channel 5 between the pump 42 and the fuel distribution mechanism 3, thereby preventing evaporation of liquid fuel from the pump 42 when the fuel cell is stored for a long time.

Insertion of the cutout valve 43 between the fuel storage part 4 and the fuel distribution mechanism 3 makes it possible to avoid, for example, inevitable consumption of a minute quantity of fuel when the fuel cell 1 is not used, or sucking failure when the pump is operated again. These greatly contribute to improvement in the practical usability of the fuel cell 1.

Using the pump 42 and cutout valve 43 in combination as described above allows supply of fuel to the MEA 2 to be controlled, thereby improving the output controllability of the fuel cell 1. In this case, the operation of the cutout valve 43 can be controlled in the same manner as the operation of the pump 42 described above.

The mechanism for feeding liquid fuel from the fuel storage part 4 to the fuel distribution mechanism 3 is not limited in particular. For example, when the installation place for use is fixed, liquid fuel may be gravity fed from the fuel storage part 4 to the fuel distribution mechanism 3. Alternatively, liquid fuel can be fed from the fuel storage part 4 to the fuel distribution mechanism 3 by capillary force by using the supply channel 5 filled with a porous body or the like. In the configuration in which fuel is supplied from the fuel distribution mechanism 3 to the MEA 2, the fuel cutout valve 43 may be disposed instead of the pump. In this case, the fuel cutout valve 43 is used to control liquid fuel via the supply channel 5. Furthermore, in order to enhance the stability and reliability of the fuel cell, the fuel cutout valve 43 may be disposed in series with the pump.

In the fuel cell according to the present embodiment, a balance valve for balancing the pressure in the fuel storage part 4 with the outside air may be mounted on the fuel storage part 4 or the supply channel 5 if required. In a fuel cell 1C shown in FIG. 13, a balance valve 60 is installed on the fuel storage part 4. The balance valve 60 comprises: a spring 62 that operates a movable valve part 61 according to the pressure in the fuel storage part 4; and a sealing portion 63 for sealing and closing the movable valve part 61.

When a liquid fuel is supplied to the fuel distribution mechanism 3A from the fuel storage part 4 and the internal pressure of the fuel storage part 4 is reduced, the movable valve part 61 of the balance valve 60 is subject to external pressure and overpowers the repulsive force of the spring 62, so that the sealing portion 63 is opened. According to the state of openness of the balance valve 60, outside air is introduced into the liquid storage part 4 so as to decrease the difference between the internal and external pressures. When the internal and external pressures are equalized, the movable valve part 61 is moved again to tightly close the sealing portion 63.

Providing, for example, the fuel storage part 4 with the balance valve 60 operated in such a manner makes it possible to inhibit the quantity of liquid fuel being fed from varying as a result of any decrease in the internal pressure of the fuel storage part 4 caused by the supply of liquid fuel. That is, when the internal pressure of the fuel storage part 4 is reduced, sucking of the liquid fuel by the pump 42 becomes unstable, causing the quantity of liquid fuel being fed to vary. Such variation in the quantity of liquid fuel being fed can be prevented by the installation of the balance valve 60. This improves the operation stability of the fuel cell 1G. When the balance valve 60 is installed in the supply channel 5, it is preferable to insert this valve between the fuel storage part 4 and the pump 42.

The liquid fuel 41 in the embodiments described above is effective for various forms of liquid fuel, and the types and the concentrations of the liquid fuels are not limited. However, when fuel density is high, the fuel distribution mechanism 3A with the plurality of fuel outlets 27a functions more obviously. Accordingly, the fuel cell in each embodiment exhibits its performance and effects especially when methanol of 80% or greater concentration is used as a liquid fuel. Accordingly, it is preferable that each embodiment be used for a fuel cell that uses methanol of 80% or greater concentration as a liquid fuel.

Having described various embodiments, it is to be understood that the invention is not limited to the embodiments and that the invention may be embodied with changes and modifications in the elements without departing from the spirit and scope thereof. The invention can be realized variously by appropriately combining any of the elements disclosed in each embodiment described above. For example, some elements may be omitted from all the elements in the embodiments. Equally, any elements in the different embodiments may be combined as necessity requires.

Only vapor changed from a liquid fuel may be supplied to the MEA. However, the present invention can be used even when some of a liquid fuel is supplied in a liquid form.

The present invention can not only supply a liquid fuel at a desired flow rate to the trailing ends of branch passages in a fuel distribution mechanism without causing air bubble blockages, but also mitigate load on a liquid feed pump.

In the present invention, even if an air bubble enters a fuel passage and an air bubble blocks, for example, one of the branch passages, fuel can be circulated using the other branch passages, thus mitigating the blockage of the fuel passage with the air bubble and allowing a stable supply of fuel to the fuel outlets. This ensures a stable output with little variation, and makes it possible to provide an excellent small power source suitable for cordless mobile electronic appliances such as mobile phones, mobile audios, mobile game machines, or notebook type personal computers.

What is claimed is:

1. A fuel cell comprising:
an membrane electrode assembly including a fuel electrode, an air electrode, and an electrolyte membrane sandwiched between the fuel electrode and the air electrode;
a fuel distribution mechanism disposed on a side of the fuel electrode of the membrane electrode assembly and configured to distribute and supply fuel to a plurality of areas of the fuel electrode;
a fuel storage part configured to store liquid fuel; and
a supply channel configured to communicate with the fuel storage part to the fuel distribution mechanism,
wherein the fuel distribution mechanism comprises:
a fuel inlet communicating with the supply channel;
a plurality of fuel outlets which are open so as to be opposite the fuel electrode; and
a fuel passage communicating with the fuel inlet and the fuel outlets in order to circulate the fuel from the fuel inlet to the fuel outlets, and
wherein the fuel passage is formed between the fuel inlet and the fuel outlets, and the fuel passage includes a plurality of branch passages that are adjusted in passage cross-sectional shape and branch structure as the branch passages extend from upstream to downstream between the fuel passage situated upstream and the fuel outlets, so as to have a desired channel resistance.

2. The fuel cell according to claim 1, wherein the branch passages diverge such that a passage cross-section gradually decreases as the branch passages extend from upstream to downstream, and trailing ends of the branch passages communicate with the fuel outlets.

3. The fuel cell according to claim 1, wherein the fuel passage is formed by one or more thin tubes.

4. The fuel cell according to claim 1, wherein an equivalent diameter of the downstream branch passages are smaller than an equivalent diameter of the upstream branch passages.

5. The fuel cell according to claim 1, wherein the fuel passage is formed so that a passage cross-section has an aspect ratio of approximately 1.

6. The fuel cell according to claim 4, wherein the branch passage has a passage cross-sectional area that is small near the corresponding fuel outlet so that a quantity of liquid fuel transported is controlled by a drive force mainly of capillary force.

7. The fuel cell according to claim 1, wherein the fuel passage is formed so as to cause the liquid fuel to flow in the branch passages so that laminar flow occurs at a Reynolds number of 2000 or below.

8. The fuel cell according to claim 1, wherein the branch passage is formed so that a total of the passage cross-sectional areas before the divergence is equal to that after the divergence, and a plurality of passage cross-sectional areas after the divergence are substantially equal to one another.

9. The fuel cell according to claim 1, wherein only one fuel inlet communicates with the supply channel.

10. The fuel cell according to claim 1, wherein at least part of the fuel passage comprises branch passages, which diverge from the fuel passage in two or more directions and then converge.

11. The fuel cell according to claim 10, wherein the branch passages are formed such that intervals between the ports increase toward the fuel outlets from the fuel inlet.

12. The fuel cell according to claim 10, wherein each branch passage has a rectangular passage cross-section with an aspect ratio of approximately 1.

13. The fuel cell according to claim 10, wherein each branch passage has an equivalent diameter by which, near the fuel outlet, the fuel is fed mainly with capillary force and a quantity of liquid fed is controlled by capillary resistance.

14. The fuel cell according to claim 11, wherein the branch passage is formed so as to cause the liquid fuel to flow in the branch passages so that laminar flow occurs at a Reynolds number of 2000 or below.

15. The fuel cell according to claim 1, wherein the branch passages are formed so as to be stacked in the fuel distribution mechanism.

16. The fuel cell according to claim 1, wherein the liquid fuel is a methanol solution or pure methanol liquid, which has a methanol concentration of 80 mol % or more.
